(19) United States
(12) Patent Application Publication
(10) Pub. No.: US 2016/0147598 A1
(43) Pub. Date: May 26, 2016

(54) OPERATING A MEMORY UNIT

(71) Applicant: HEWLETT-PACKARD DEVELOPMENT COMPANY, L.P., Houston, TX (US)

(72) Inventors: Naveen Muralimanohar, Palo Alto, CA (US); Erik Ordentlich, Palo Alton, CA (US)

(73) Assignee: Hewlett-Packard Development Company, L.P., Houston, TX (US)

(21) Appl. No.: 14/899,669

(22) PCT Filed: Jul. 31, 2013
(86) PCT No.: PCT/US2013/052922

§ 371 Date: Dec. 18, 2015

(51) Int. Cl. G06F 11/10

(52) U.S. Cl. CPC G06F 11/1064; G06F 11/1016

(57) ABSTRACT

A method for operating a memory unit is disclosed. The method includes encoding data from a cache line divided in a plurality of groups and generating a plurality of codewords. The method further includes storing the LED data for the cache line combined with the data of the cache line retrieved from a first portion of the codewords across a plurality of chips in the memory unit to create a first tier of protection. The method also includes storing the GEC data for the cache line retrieved from a second portion of the codewords across the plurality of chips to create a second tier of protection for the cache line. The method also includes receiving information corresponding to the first tier of protection, determining whether an error exists in the data of the cache line, decoding the data of the cache line, and outputting the data of the cache line at the controller.

### CROSS-REFERENCE TO RELATED APPLICATIONS

This patent application is related to co-pending PCT Patent Application No. ______ (Attorney Docket No. 83272535) and co-pending PCT Patent Application No. ______ (Attorney Docket No. 83273853), concurrently filed herewith.

### BACKGROUND

In modern, high-performance serer systems that include complex processors and large storage devices, memory system reliability is a serious and growing concern. It is of critical importance that information in these systems is stored and retrieved without errors. When errors actually occur during memory access operations, it is also important that these errors are successfully detected and corrected.

### BRIEF DESCRIPTION OF THE DRAWINGS

FIG. 1 is a schematic illustration of an example of a system including a memory controller and a coding module.

FIG. 2 illustrates a schematic representation showing an example of a memory module.

FIG. 3 is a schematic illustration showing an example of a memory module rank.

FIG. 4 is a schematic illustration showing an example of a cache line.

FIG. 5 illustrates a flow chart showing an example of a method for operating a memory unit.

FIGS. 6A and 6B illustrate a flow chart showing an example of method for decoding data received from a memory unit.

FIGS. 7A and 7B illustrate a flow chart showing an example of an alternative method for operating a memory unit.

### DETAILED DESCRIPTION

A memory protection mechanism that provides better efficiency by offering a two-tier scheme that separates out error detection and error correction functionality is disclosed. The memory protection mechanism avoids one or more of the following: activation of a large number of memory chips during every memory access, increase in access granularity, and increase in storage overhead. The memory protection mechanism activates as few chips as possible on each memory access, conserves energy, leads to decreased dynamic random access memory (DRAM) access times, and improves system performance.

As described in additional detail below, the first layer of protection in the memory protection mechanism is local error detection (LED), an immediate check that follows every access operation (i.e., read or write) to verify data fidelity. To ensure chip-level detection (required for chipkill-level reliability), LED information may be maintained per chip. In other words, LED information may not be associated with each cache line (also called a line of data) as a whole, but with every cache line “segment”, the fraction of the cache line present in a single chip in a rank of memory. In some examples, a relatively short checksum (e.g., 1's complement, Fletcher's sums, or other) computed over a cache line segment may be used as the error detection code and may be appended to the data. The LED information is attached to the data and a read request from the memory controller automatically sends the LED along with the data.

If the LED detects an error, the second layer of protection is then applied. The second layer of protection is the Global Error Correction (GEC), which may be stored in either the same row as the data segments or in a separate row that exclusively contains GEC information for several data rows. Unlike LED, the memory controller has to specifically request for GEC data of a detected failed cache line.

As further explained in additional detail below, the memory protection mechanism comprises a memory module that includes a reduced number of chips (e.g., DRAM chips). In one example, a rank of memory includes nine x8 chips and a burst of eight. Each memory operation may involve a cache line of 64 bytes. In the memory, data corresponding to one cache line is spread across all the chips in the rank. LED data and GEC data are also distributed among the chips in a rank. Because the system proposes a reduced number of chips, it increases the bits stored per chip for a cache line. Therefore, more redundancy on each chip is needed to protect the data in case of chip failure because the failure is likely to affect more bits. The required additional redundancy per chip must be in line with the specific data access granularities and the burst rate of the system.

In addition, because of the configuration of the described system, some failures in the memory may not be detected. Specifically, this may occur when the system uses simple parity and checksum to detect and recover from failure. Using checksum/parity cannot guarantee detector of any arbitrary set of failures across the data stored in all chips of the rank. It is possible that one in 2̂n failures may go undetected, where “n” is the number of checksum/parity bits in a single chip of the memory rank (i.e., in the described implementation they correspond to the LED bits). Therefore, in memory devices where random errors are likely, a simple checksum may not be sufficient to guarantee error free operations. Although, most errors in DRAM include specific patterns and relate to a specific category, new sources of errors may arise in emerging technologies and may result in silent error corruption.

Therefore, the description proposes systems, methods, and computer readable media that improve detection and correction of random errors in a rank of memory and eliminates undetected error patterns. In some implementations, the description proposes a system for operating a memory unit. The system includes a processor having a memory controller in communication with the memory unit. The memory controller is to perform an encoding operation to divide data in a cache line into a plurality of groups, encode the data in the plurality of groups to generate a plurality of codewords that include the data of the cache line, local error detection (LED) data for the cache line, and global error correction (GEC) data for the cache line. The encoding operation is further to generate a first tier of protection for the cache line from a first portion of the plurality of codewords, where the first tier of protection is stored across a plurality of chips in the memory and includes LED data for the cache line combined with the data of the cache line. The encoding operation is also to generate a second tier of protection for the cache line from a second portion of the plurality of codewords, where the second tier of protection is distributed among the plurality of chips and includes the GEC data for the cache line. The memory controller is also to perform a decoding operation to determine whether an error exists in the data of the cache line based on received information corresponding to the first tier of protection, decode the data of the cache line using a decoder, and output the data of the cache line at the controller.

In other example implementations, the description proposes a method for operating a memory unit. The method includes encoding a cache line of data from the memory unit to generate a codeword, where the codeword includes the encoded cache line, local error detection (LED) information for the cache line, and global error correction (GEC) information for the cache line. The method also includes storing data associated with the codeword at a plurality of data chips of the memory unit, receiving a first portion of the codeword corresponding to the cache line and the LED information at a controller, determining whether there is an error in the encoded cache line by using the received first portion of the codeword, receiving a second portion of the codeword corresponding to the GEC information, and combining the second portion with the first portion at the controller to create a received codeword. The method further includes decoding the received codeword to retrieve the encoded cache line. Decoding the received codeword includes erasing, in order, data from the received codeword corresponding to each of the plurality of data chips, and determining whether erased data associated with a chip includes the error by operating a decoder, wherein the decoder is an erasure decoder. Decoding the received codeword further includes decoding the received codeword when the data associated with the chip that includes the error is erased, reconstructing data on the received codeword corresponding to the data on the chip, and outputting the cache line at the controller.

In the following detailed description, reference is made to the accompanying drawings, which form a part hereof, and in which is shown by way of illustration specific examples in which the disclosed subject matter may be practiced. It is to be understood that other examples may be utilized and structural or logical changes may be made without departing from the scope of the present disclosure. The following detailed description, therefore, is not to be taken in a limiting sense, and the scope of the present disclosure is defined by the appended claims. Also, it is to be understood that the phraseology and terminology used herein is for the purpose of description and should not be regarded as limiting. The use of “including”, “comprising” or “having” and variations thereof herein is meant to encompass the items listed thereafter and equivalents thereof as well as additional items. It should also be noted that a plurality of hardware and software based devices, as well as a plurality of different structural components may be used to implement the disclosed methods and systems.

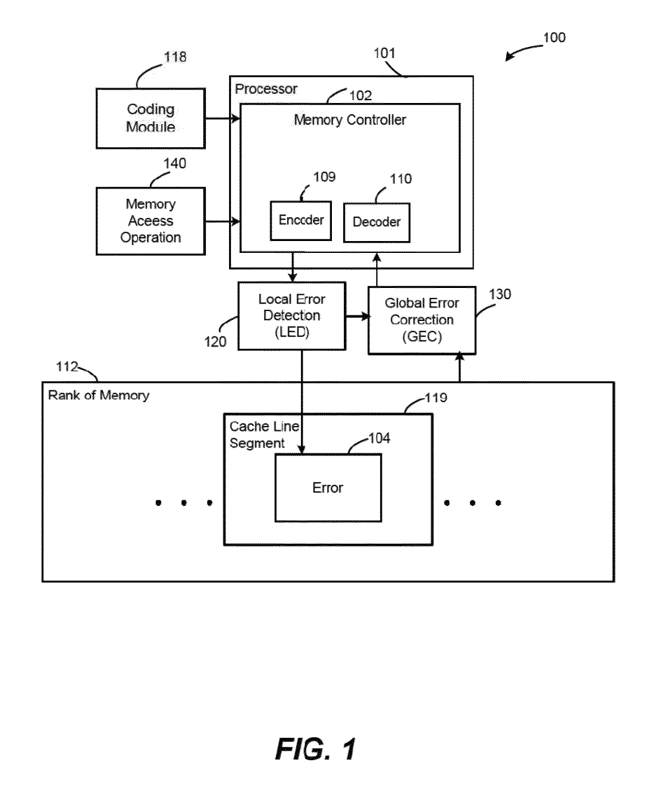

FIG. 1 is a schematic illustration of an example of a system 100 (e.g., a server system, a computer system, etc.) including a processor 101 (e.g., a central processing unit, etc.), a memory controller 102, and a coding module 118 for controlling the encoding/decoding operation of data in the memory during a memory access to enable detection and correction of random errors. The processor 101 may be implemented using any suitable type of processing system where at least one processor executes computer-readable instructions stored in a memory. In some examples, the system 100 may include more than one processor. The system 100 further includes a memory unit or module 112 (represented as a rank of dual-in-line memory module (“DIMM”) in FIG. 1) and a system bus (e.g. a high-speed system bus, not shown). In other examples, the system 100 includes additional, fewer, or different components for carrying out similar functionality described herein.

The processor 101 and the memory controller 102 communicate with the other components of the system 100 by transmitting data, address, and control signals over the system bus. In some examples, the system bus includes a data bus, an address bus, and a control bus (not shown). Each of these buses can be of different bandwidth.

The memory controller 102 includes an encoder 109 and a decoder 110. Alternatively, the encoder 109 and the decoder 110 may be located on the memory module 112. It is to be understood that the memory controller 102 includes other components that are not shown in the figures. For example, the controller 102 may include the following unshown components: a cache, a data selector, an address selector, buffers, control logic for scheduling request to memory units, receiving data from memory units, and forwarding the received data or other control signals to the other parts of the system.

The encoder 109 is to encode data written to the memory unit during a memory access operation with redundancy data or an error detection code to generate codewords. During a read operation, the data stored in the memory rank and the redundancy data (i.e., the codewords) is provided to the memory controller 102. The decoder 110 may be used by the memory controller 102 to decode the provided data. The controller checks the consistency of the cache line delivered from the memory unit. Thus, by using the decoded data, the memory controller determines whether an error exists in the transferred data or in one of the chips of the memory storing the data.

In some examples, the functions of the encoder 109 and the decoder 110 may be implemented through a set of instructions (e.g., via the coding module 118) and can be executed in software. The coding module 118 may be stored in any suitable configuration of volatile or non-transitory machine-readable storage media in the memory controller 102 or elsewhere on the system 100. The machine-readable storage media are considered to be an article of manufacture or part of an article of manufacture. An article of manufacture refers to a manufactured component. Software stored on the machine-readable storage media and executed by the processor may include, for example, firmware, applications, program data, filters, rules, program modules, and other executable instructions. The controller may retrieve from the machine-readable storage media and executes, among other things, instructions related to the control processes and methods described herein.

The general operation of the system is described in the following paragraphs. In response to a memory access operation 140 (e.g., read or write), the system 100 is to apply local error detection operation 120 and/or global error correction operation 130 to detect and/or correct an error 104 of a cache line segment 119 of the rank 112 of memory. In one example, system 100 is to compute local error detection (LED) information per cache line segment 119 of data. The cache line segment 119 may be associated with a rank 112 of memory. The LED information is to be computed based on an error detection code. In one example the system 100 is to generate a global error correction (GEC) information or the cache line segment 119 based on a global parity. The system 100 is to check data fidelity in response to memory access operation 140, based on the LED information, to identify a presence of an error 104 and the location of the error 104 among cache line segments 119 of the rank 112. The system 100 is to correct the cache line segment 119 having the error 104 based on the GEC information, in response to identifying the error 104.

In some examples, the system 100 may use simple checksums and parity operations to build a two-layer fault tolerance mechanism, at a level of granularity down to a segment 119. However, as explained in additional detail below, these simple checksums and parity operations may not be sufficient to detect all random errors in the memory and the description proposes an improved coding technique to address this issue.

In the described system, the first layer of protection may be local error detection (LED) 120, a check (e.g., an immediate check that follows a memory read operation) to verify data fidelity. The LED 120 can provide chip-level error detection (for chipkill, i.e., the ability to withstand the failure of an entire DRAM chip), by distributing LED information 120 across a plurality of chips in a memory module. Thus, the LED information 120 may be associated not only with each cache line as a whole, but with every cache line “segment,” i.e., the fraction of the line present in a single chip in the rank.

A relatively short checksum (e.g., complement, Fletcher's sums, or other) may be used as the error detection code, and may be computed over the segment and appended to the data. The error detection code may be based on other types of error detection and/or error protection codes, such as cyclic redundancy check (CRC), Bose, Ray-Chaudhuri, and Hocquenghem (BCH) codes, and so on. The layer-1 protection (LED 120) may not only detect the presence of an error, but also pinpoint a location of the error, i.e., locate the chip or other location information associated with the error 104.

If the LED 120 detects an error, the second layer of protection may be applied—the Global Error Correction (GEC) 130. In some examples, the GEC 130 may be based on a parity, such as an XOR-based global parity across the data segments 119 on the data chips in the rank 112 (e.g., N such data chips). The GEC 130 also may be based on other error detection and/or error protection codes, such as CRC, BCH, and others. In some examples, the GEC results may be stored in either the same row as the data segments, or in a separate row that is to contain GEC information for several data rows. Data may be reconstructed based on reading out the fault-free segments and the SEC segment, and location information (e.g., an identification of the failed chip based on the LED).

In some examples, the LED information and GEC information may be computed over the data words in a single cache line. Thus, when a dirty line is to be written back to memory from the processor, there is no need to perform a “read-before-write,” and both codes can be computed directly, thereby avoiding impacts to write performance. Furthermore, LED information and/or GEC information may be stored in regular data memory, in view of a commodity memory system that may provide limited redundant storage for Error-Correcting Code (ECC) purposes. An additional read/write operation may be used to access this information along with the processor-requested read/write. Storing LED information in the provided storage space within each row may enable it to be read and written in tandem with the data line. In some examples, the GEC information can be stored in data memory in a separate cache line since it may only be accessed in the very rare case of an erroneous data read. Appropriate data mapping can locate this in the same row buffer as the data to increase locality and hit rates.

The memory controller 102 may provide data mapping, LED data/GEC data computation and verification (i.e., assist with encoding and decoding of the data from the memory), GEC information storage, and perform additional reads if required, etc. Thus, system 100 may provide full functionality transparently, without a need to notify and/or modify an Operating System (OS) or other computing system components. Setting apart some data memory to store LED data/GEC data may be handled through minor modifications associated with system firmware, e.g., reducing a reported amount of available memory storage to accommodate the stored LED data/GEC data transparently from the OS and application perspective.

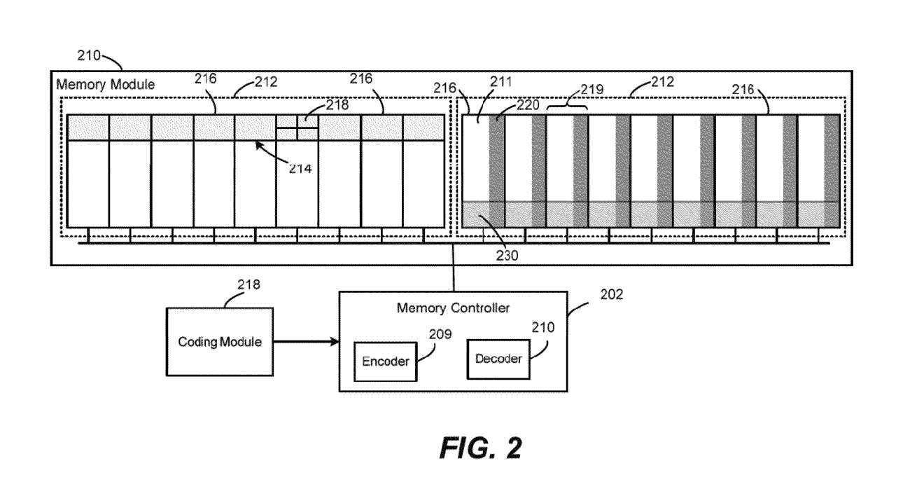

FIG. 2 is a schematic representation of an example of a memory module 210. The memory module 210 may interface with memory controller 202 and can send data, LED information, and GEC information to the memory controller 202. In one example, the memory module 210 may be a Joint Electron Devices Engineering Council (JEDEC)-style double data rate (DDRx, where x=1, 2, 3, . . . ) memory module, such as a Synchronous Dynamic Random Access Memory (SDRAM) configured as a dual in-line memory module (DIMM). Each DIMM may include at least one rank 212, and a rank 212 may include a plurality of DRAM chips 216. Two ranks 212 are shown in FIG. 2, each rank 212 including nine chips 218. A rank 212 may be divided into multiple banks 214, each bank distributed across the chips 216 in a rank 212. Although one bank 214 is shown spanning the chips in the rank, a rank may be divided into, e.g., 4-16 banks. Each bank 214 may be processing a different memory request. The portion of each rank 212/bank 214 in a chip 216 is a segment or a sub-bank 219. When the memory controller 202 issues a request for a cache line, the chips 216 in the rank 212 are activated and each segment 219 contributes a portion of the requested cache line. Thus, a cache line is striped across multiple chips 216.

In an example having a data bus width of 64 bits, and a cache line of 64 bytes, the cache line transfer can be realized based on a burst of 8 data transfers. A chip may be, an xN part, e.g., x4, x8, x16, x32, etc. This represents an intrinsic word size of each chip 216, which corresponds to the number of data I/O pins on the chip. Thus, an xN chip has a word size of N, where N refers to the number of bits going in/out of the chip on each clock tick. Each segment 219 of a bank 214 may be partitioned into N arrays 218 (four are shown). Each array 218 can contribute a single bit to the N-bit transfer on the data I/O pins for that chip 216. An array 218 has several rows and columns of single-bit DRAM cells.

In one example, each chip 216 may be used to store data 211, LED information about 220, and GEC information about 230. Accordingly, each chip 216 may contain a segment 219 of data 211, LED information 220, and GEC information 230. This can provide robust chipkill protection, because each chip can include the data 211, LED data 220, and GEC data 230 for purposes of identifying and correcting errors.

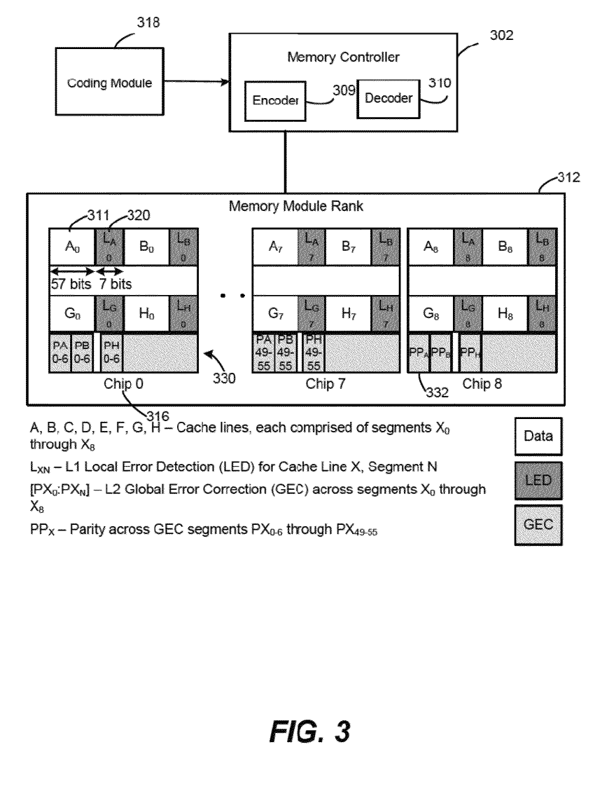

FIG. 3 is a schematic illustration showing an example of a memory module rank 312. In one example, the rank 312 may include N chips, e.g., nine x8 DRAM chips 316 (chip 0 . . . chip 8), and a burst length of 8. In alternate examples, other numbers/combinations of N chips may be used, at various levels of xN and burst lengths. The data 311, LED data 320, and GEC data 330 can be distributed throughout the chips 316 of the rank 312. The rank 312 includes a plurality of adjacent cache lines A-H each comprised of segments X₀-X₈, where the data 311, LED data 320, and GEC data 330 are distributed on the chips 316 for each of the adjacent cache lines.

In one example, LED data 320 can be used to perform an immediate check following every memory access operation (e.g., read operation) to verify data fidelity. Additionally, LED data 320 can be used to identify a location of the failure, at a chip-granularity within rank 312. As noted above, to ensure such chip-level detection (required for chipkill), the LED data 320 can be maintained at the chip level (i.e., at every cache line “segment,” the fraction of the line present in a single chip 316 in the rank 312). Cache line A may be divided into segments A0 through A8, with the associated local error detection codes LA0 trough LA8.

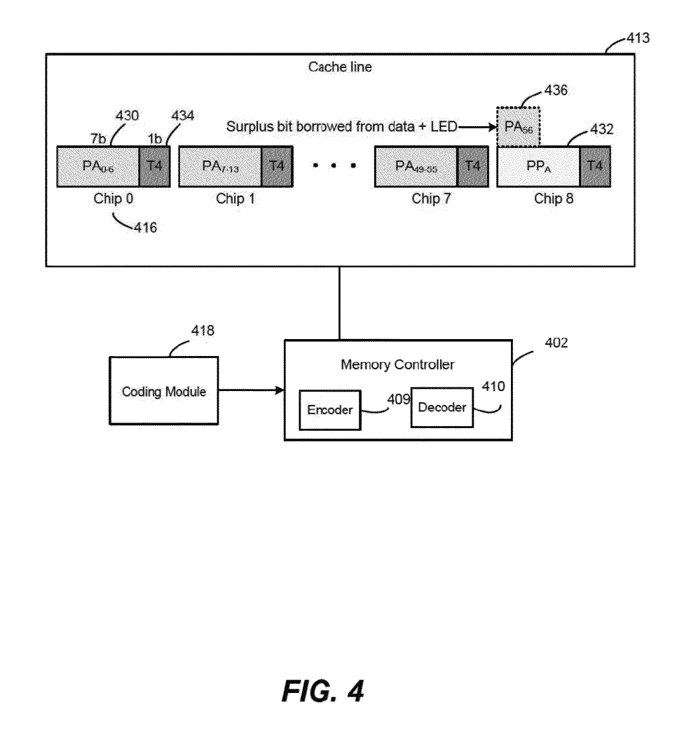

Each cache line in the rank 312 may be associated with 64 bytes of data, or 512 data bits, associated with a data operation, such as a memory access request. Because 512 data bits (one cache line) in total are needed, each chip is to provide 57 bits towards the cache line. For example, an x8 chip with a burst length of 8 supplies 64 bits per access, which are interpreted as 57 bits of data (A0 in FIG. 3, for example), and 7 bits of LED information 320 associated with those 57 bits (LA0). The proposed coding mechanism for computing the LED data is described in additional detail below. A physical data mapping policy may be used to ensure that LED bits 320 and the data segments 311 they protect are located on the same chip 316. One bit of memory appears to remain unused for every 576 bits, since 57 bits of data multiplied by 9 chips is 513 bits, and only 512 bits are needed to store the cache line. However, this “surplus bit” is used as part of the second layer of protection (e.g., GEC), details of which are described in reference to FIG. 4.

The choice of error correction code for the data 311 and the LED data 320 can depend on an expected failure mode and the specifications of the system. In some examples, a systematic error correction code may be used, where the input data from the cache line is embedded in the encoded output (i.e., a portion of the encoded word is obtained by copying the data 311). Alternatively, a non-systematic code may also be used, where the encoded output does not directly copy the input data 311.

The GEC data 330, also referred to as a Layer 2 Global Error Correction code, is to aid in the recovery of lost data once the LED data 320 (Layer 1 code) detects an error and indicates a location of the error. The GEC code 330 may be a 57-bit entity, and may be provided as a column-wise XOR parity of nine cache line segments, each a 57-bit field from the data region. For cache line A, for example, its GEC data 330 may be a parity, such as a parity PA that is a XOR of data segments A0, A1, . . . , A8. Data reconstruction from the GEC 330 code may be a non-resource intensive operation (e.g., an XOR of the error-free segments and the GEC 330 code), as the erroneous chip 316 can be flagged by the LED data 320.

Because there isn't a need for an additional dedicated ECC chip (what is normally used as an ECC chip on a memory module rank 312 is instead used to store data+LED 320), the GEC code may be stored in data memory itself, in contrast to using a dedicated ECC chip. The available memory may be made to appear smaller than it physically is from the perspective of the operating system, via firmware modifications or other techniques. The memory controller also may be aware of the changes to accommodate the LED data 320 and/or GEC data 330, and may map data accordingly (such as mapping to make the LED data 320 and/or GEC data 330 transparent to the OS, applications, etc.).

In order to provide strong fault-tolerance of one dead chip 316 in nine for chipkill, and to minimize the number of chips 316 touched on each access, the GEC code 330 may be placed in the same rank as its corresponding cache line. A specially-reserved region (lightly shaded GEC data 330 in FIG. 3) in each of the nine chips 316 in the rank 312 may be set aside for this purpose. The specially-reserved region may be a subset of cache lines in every DRAM page (row), although it is shown as a distinct set in FIG. 3 for clarity. This co-location may ensure that any reads or writes to the GEC 330 information produces a row-buffer hit when made in conjunction with the read or write to the actual data cache line, thus reducing any potential impacts to performance.

FIG. 4 is a schematic illustration showing example of cache line 413 including a surplus bit 436. As noted above each rank may include a plurality of adjacent cache lines, where each of the chips in the rank includes GEC information. In one example, the GEC information 430 may be laid out in a reserved region across N chips (e.g., Chip 0 . . . 8), for example as cache line A, also illustrated in FIG. 3. The cache line 413 also may include parity 432, tiered parity 434, and surplus bit 436. The adjacent cache lines (not shown) in the rank also have a similar configuration of the GEC information.

Similar to the data bits as shown FIG. 3, the 57-bit GEC data 420 may be distributed among all N (i.e., nine) chips 419 in the rank. Fur example, the first seven bits of the PA field (PA0-6) may be stored in the first chip 416 (Chip 0), the next seven bits (PA7-13) may be stored n the second chip (Chip 1), and so on. Bits PA49-55 may be stored on the eighth chip (Chip 7). The last bit, PA56 may be stored on the ninth chip (Chip 8), in the surplus bit 438. The surplus bit 436 may be borrowed from the Data+LED region of the Nth chip (Chip 8), as set forth above regarding using only 512 bits of the available 513 bits (57 bits×9 chips) to store the cache line.

The failure of a chip 416 also results in the loss of the corresponding bits in the GEC 430 information stored in that chip. The GEC code 430 PA itself, therefore, is protected by an additional parity 432, also referred to as the third tier PP_{A}. PP_{A} in the illustrated example is a 7-bit field, and is the XOR of the N−1 other 7-bit fields, PA0-6, PA7-13, . . ., PA49-55. The parity 432 (PP_{A} field) i5 shown stored on the Nth (ninth) chip (Chip 8). If an entire chip 416 fails, the GEC 430 is first recovered using the parity 432 combined with uncorrupted GEC segments from the other chips. The chips 416 that are uncorrupted may be determined based on the LED, which can include an indication of an error's location. The full GEC 430 is then used to reconstruct the original data in the cache line.

The tiered parity 434 or the remaining 9 bits of the nine chips 416 (marked T4, for Tier-4, in FIG. 4) may be used to build an error detection code across GEC bits PA₀ through PA₅₅, and PP_{A} in some situations. One example is a scenario where there are two errors present in the bank of chips (e.g., one of the chips has completely failed and there is an error in the GEC information in another chip). Note that neither exact error location information nor correction capabilities are required at this stage because the reliability target is only to detect a second error, and not necessarily correct it. A code, therefore, may be built using various permutations of bits from the different chips to form each of the T4 bits 434.

Therefore, in the above-described example implementation, for each memory access operation involving a 64-byte (512-bt) cache line in a rank with nine x8 chips, the following bits may be used: 63 bits of LED information, at 7 bits per chip; 57 bits of GEC parity, spread across the nine chips; 7 bits of third-tier parity, PP_{X}; and 9 bits of T4 protection, 1 bit per chip. As noted above, the memory in system 100 includes fewer chips (e.g., nine) as compared to a conventional memory system. Data, LED, and GEC corresponding to one cache line is spread across all the chips in the rank. It is to be understood that the described system may include other implementations of the memory unit (e.g., nine x16 chips and a burst length of four, etc.).

The reduced number of chips in the described implementation increases the total bits stored per chip for a single cache line. Consequently, more redundancy on each chip is needed to protect the data in case of chip failure because the failure is likely to affect more bits. The required additional redundancy per chip must correspond to the specific data access granularities and the burst rate described above.

Further, the implementation described above proposes using uses simple parity and checksum to detect and recover from failures. In that situation, not all failures in the memory may be detected. Using checksum/parity cannot guarantee detection of any random set of failures across the data stored in all chips of the rank. It is possible that one in 2̂n failures may be undetected, where “n” is the number of LED or parity bits in a single chip of the memory rank. Thus, in the above-described example that includes nine x8 DRAM chips and each chip provides 57 bits of data and 7 bits of one in 128 errors is not going to be detected.

Therefore, in memory devices where random errors are likely, simple checksum is not sufficient to guarantee error free operations. While in DRAM most errors, manifest as stuck-at-fault—an entire row or a column or a single bit may get stuck to either zero or one, and checksum sufficient to catch these errors, switching to NVRAM creates new sources of errors and can result in silent data corruption. For example, PCRAM cells tend to drift over time and the rate of drift can vary depending on the process variation, resulting in random errors in a cache line.

Therefore, the systems, methods, and computer readable media described herein propose using novel coding approaches for data stored on a memory unit during a memory access operation. The proposed coding approaches detect all single chip errors in a rank regardless of the error pattern, and may simultaneously correct a vast majority of the detected errors.

Error correction codes protect data against errors during a memory access operation. In most cases, the data subject to the memory access operation is encoded using an error-correcting code prior to storage. The additional information (i.e., redundancy) added by the code is used by the memory controller to recover the original data. It is understood that the present invention is applicable to both systematic encoders that copy the data into part of the codeword during encoding and storage, as well as to non-systematic encoders that do not copy the data into the codeword prior to encoding. Any one of a number of different codes may be used.

A code generally includes a set of symbol vectors all of the same length (e.g., 4 bits, 1 byte, 4 bytes, etc.). These symbol vectors that belong to a code are called codewords. In one example, a known way of describing an error correction code is to show its parity check matrix. This parity check matrix identifies precisely which vectors are valid codewords of the code.

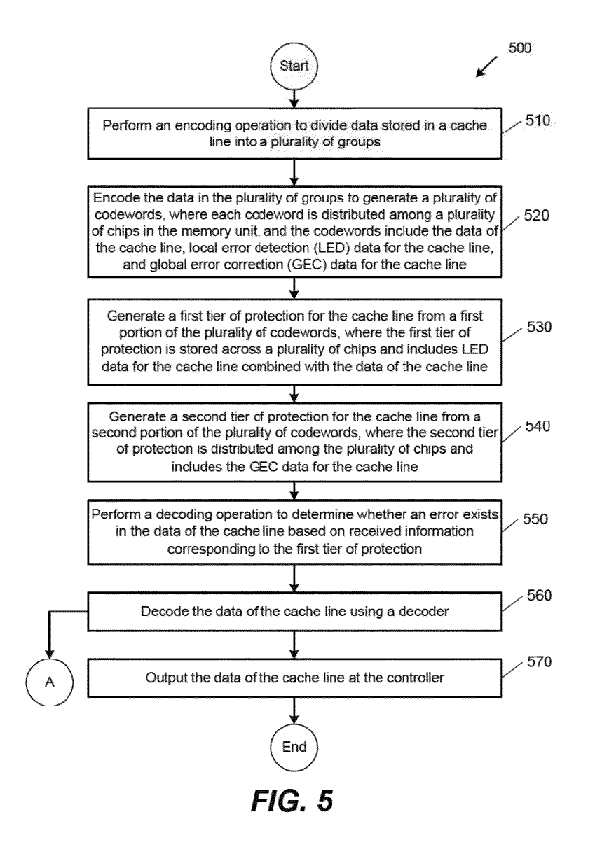

FIG. 5 illustrates a flow chart showing an example of a method 500 for operating a memory unit (e.g., the memory module 112, 210, etc.) during a memory access operation. In one example, the method 500 can be executed by the memory controller 102 of the processor 1. In other example, the method 500 can be executed by a control unit of another processor (not shown) of the system. Various steps described herein with respect to the method 500 are capable of being executed simultaneously, in parallel, or in an order that differs from the illustrated serial manner of execution. The method 300 is also capable of being executed using additional or fewer steps than are shown in the illustrated examples. The method 500 may be executed in the form of instructions encoded on a non-transitory machine-readable storage medium executable by a processor 101. In one example, the instructions for the method 500 are stored in the coding module 118.

The method 500 begins at step 510, where the memory controller begins to perform an encoding operation that is based on a first memory access request (e.g., memory write). At step 510, the controller divides data in a cache line into a plurality of groups. As noted above, the memory unit of the system includes nine x8 data chips and a burst length of eight, where the cache line may include 64 bytes of data. In one example, the controller divides the cache line into eight groups, where each group includes eight bytes of data.

Next, the controller encodes (e.g., by using the encoder 109) the data in the plurality of groups to generate a plurality of codewords, where each codeword is distributed among a plurality of chips in the memory unit, and the codewords include the data of the cache line, local error detection (LED) data for the cache line, and global error correction (GEC) data for the cache line (at step 520). In one example, code used by the encoder is a (10, 8, 3) systematic code. In other words, the code includes codewords of ten symbols each symbol being one byte, the code encodes eight symbols/bytes of input data, and the codewords have a minimum distance of three symbols (i.e., any two codewords in the code differ in at least that many symbols). Thus, the encoder generates eight codewords of length ten symbols and can correct one byte symbol errors. As explained in additional detail below, the encoder also generates an additional byte of GEC data to complete a total of 81 encoded bytes (64 bytes of data, 8 bytes of LED data, and 9 bytes of GEC data). The eight codewords and GEC are spread across the nine chips in the rank (i.e., they are not stored one codeword per chip). In other words, each chip stores a portion of each of the codewords and GEC. The proposed coding scheme corrects all but a fraction of approximately ½⁴⁶ single column error patterns (i.e., all single column error patterns with two or fewer error patterns are corrected), while also simultaneously detecting all such error patterns.

At step 530, the controller generates a first tier of protection for the cache line from a first portion of the plurality of codewords, where the first tier of protection is stored across the plurality of chips on the memory and includes LED data for the cache tine combined with the data of the cache line. In one example, each of the generated ode words includes eight bytes of data and two bytes of redundancy. The first nine bytes of each codeword (that correspond to eight bytes of data and one byte of LED data) are copied to the nine different chips of the memory rank, to define the first tier of protection. For example, each of the nine chips stores coded data bytes plus one LED byte for each of the eight codewords (i.e., the codewords are distributed among all chips). As noted earlier, after the memory access operation (e.g., a memory read operation), the controller receives the requested cache line together with the LED data to determine whether an error exists in the data. This configuration of the first layer of protection applies when the system uses a systematic code. When non-systematic code is used, the data in the first layer of protections is only implicitly included.

Next, the controller generates a second tier of protection for the cache line from a second portion of the plurality of codewords (at step 540). The second tier of protection is distributed among the plurality of chips in the memory and includes the GEC data for the cache line. For example, the controller uses the last (i.e., tenth) byte from each of the eight codewords and stores each of these bytes on corresponding nine chips in the memory unit as GEC data. Thus, eight GEC bytes are stored on the first eight chips of the rank. A simple parity of the eight tenth bytes from the codewords is computed and stored in the ninth chip to complete the second tier of protection (i.e., the GEC data).

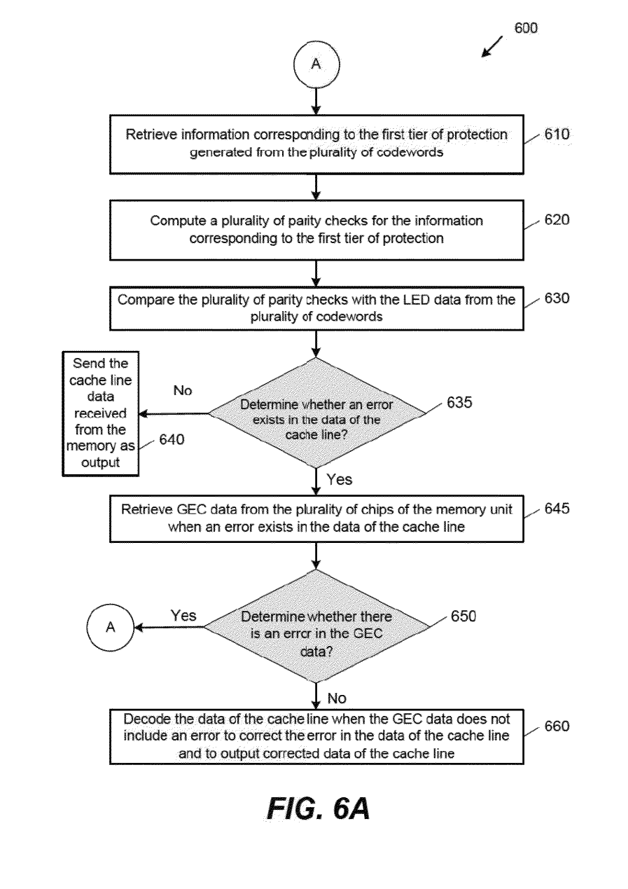

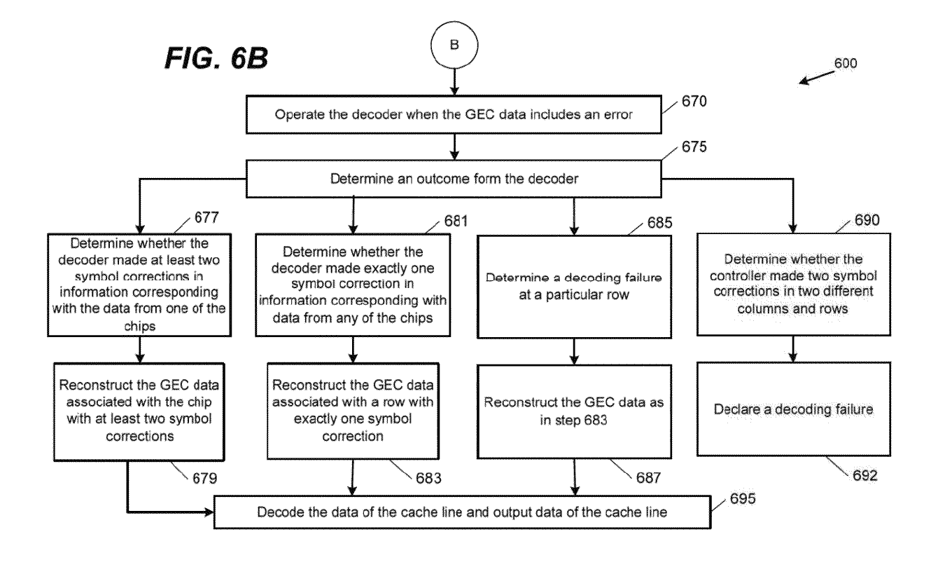

At step 550 the controller performs a decoding operation based on a memory access operation (e.g., read request). It is to be understood that the decoding operation may not automatically follow the encoding of the data but may be based in a subsequent read request from the controller. The decoding operation determines whether an error exists in the data of the cache line based on received information corresponding to the first tier of protection. During the decoding operation, the controller decodes the data of the cache line using a decoder (at step 560). The method of decoding the data in the cache lime is described in more detail below in relation to FIGS. 6A and 6B. After decoding the data the controller outputs the data of the cache line.

As noted above, the encoder may be a systematic encoder and the input data from the cache line may be embedded in the encoded input without being manipulated by the encoder. On the other hand, the encoder may be a non-systematic encoder, and the input data from the cache line may be manipulated prior to encoding and storage by the encoder.

FIGS. 6A and 6B illustrate a flow chart showing an example of a method for decoding data received from a memory unit. In one example, method 600 can be executed by the memory controller 102 of the processor 101. Various steps described herein with respect to the method 600 are capable of being executed simultaneously, in parallel, or in an order that differs from the illustrated serial manner of execution. The method 600 may be executed in the form of instructions encoded on a non-transitory machine-readable storage medium executable by a processor 101. In one example, the instructions for the method 600 are stored in the coding module.

The method 600 begins at step 610, where the controller retrieves information corresponding to the first layer of protection from the plurality of codewords. In one example, based on a read request, the controller receives information that corresponds to the first layer of protection and includes the encoded cache line (which may be erroneous) and the LED associated with the cache line. With respect to the implementation described above, the information that corresponds to the first layer of protection may be 72 bytes—64 bytes of data and 8 bytes of LED information. The controller then computes a plurality of parity checks for the information corresponding to the first layer of protection (at step 620). In one example, the controller computes nine panties with respect to the (10, 8, 3) code based on the eight bytes of cache line data stored across the nine chips of the rank of memory.

At step 830, the controller compares the plurality of parity checks with the LED data from the plurality of codewords (i.e., the ninth byte from the codeword). The controller determines whether an error exists in the data of the cache line (at step 835). For example, if all computed parities and the bytes of LED data match, the controller determines that there is no error in the transmitted cache line. In that case, at step 640, the controller sends the cache line data received from the memory as output (i.e., when the cache line was coded with a systematic code).

If at least one of the panty checks fails, the controller determines that there is an error in the received cache line (i.e., a chip failure). When an error exists in the data of the cache line, the controller retrieves GEC data from the plurality of chips of the memory unit (at step 645). In one example, when the GEC is retrieved from the memory, the bytes from the first tier of protection (data+LED) and the first eight bytes of GEC are arranged into an 8×10 array of bytes, where the GEC bytes correspond to the tenth column of the array. Each of the eight rows of the 8×10 array includes the data bytes plus one LED byte from the codewords. In addition, each of the eight GEC bytes is aligned with the corresponding row of data/LED for which it serves as a second parity byte. The created 8×10 array corresponds to the data from the eight codewords of ten bytes generated by the encoder. The ninth GEC byte is part of and is retrieved with the GEC data but is not put into the array. It is used to check if there is an error in the GEC data and then, during decoding, the ninth byte of GEC is used to correct one of first eight GEC bytes if there is an error.

The controller then applies a standard one error correcting decoder for the (10, 8, 3) code to each row in the 8×10 array, where decoding decisions are made based on the following steps. At step 650, the controller determines whether there is an error in the GEC data. When there is a chip failure, errors may exist not only in the data stored in the segment of the chip but also in the GEC data stored in the chip. Therefore, there may be a row in the created 8×10 array that may have two bytes in error. In one example, the controller uses the ninth parity byte of GEC data from the memory to determine whether an error exists in the first eight bytes of GEC data retrieved by the controller. When the controller identifies that there is no error in the eight bytes of GEC data, the controller may determine that there is only one error per row of the 8×10 array. Then, the controller uses a row-by-row decoder (e.g., one error correcting decoder for the corresponding code used to encode the rows) to decode each row of the 8×10 array of the data of the cache line to correct the error in the data of the cache line and to output corrected data of the cache line (at step 660).

With continued reference to FIG. 6B, when the controller determines that the GEC data includes an error, potentially one row in the 8×10 array may have two errors. In that case, the controller continues to operate the above row-by-row decoder on each row of the 8×10 array as a preliminary decoder in order to decode the encoded cache line (at step 670). The controller then determines the outcome of this decoder in order to proceed with the overall decoding operation (at step 675). The controller may determine whether the row-by-row decoder made at least two symbol corrections in information corresponding with the data from one of the chips (at step 677). In other words, the controller evaluates the 8×10 array during the decoding process to determine if a column (e.g., a column with index “A”) in the array (where the data in the column corresponds to the data from a chip of the memory) contains at least two symbol error corrections (i.e., each symbol is equivalent to one byte of data). For example, the controller compares the input to the row-by-row decoder with the output of the row-by-row decoder. If the controller determines that the decoder made at least two symbol corrections in information corresponding with the data from one of the columns/chips, the controller reconstructs the GEC data associated with the chip with at least two symbol corrections (at step 679). For example, in the 8×10 array, the controller corrects the byte of GEC data (e.g., byte “A”) by using a parity of the eight remaining GEC data bytes and replaces the failed GEC byte in rcw “A” with the corrected byte. The controller then moves to step 695 to decode the data of the cache line and outputs the data of the cache line.

The controller may determine whether the row-by-row decoder made exactly one symbol correction in information corresponding with data from any of the chips (at step 681). In other words, the controller evaluates the 8×10 array during the decoding process to determine if an of the first eight columns in the array contains exactly one error correction. In one example, the one correction may have been due to a miscorrection because they were two bytes of error in a row—one due to the chip affecting the data/LEC data and another to the GEC data. Again, the controller compares the input to decoder with the output of the decoder. If the controller determines that the row-by-row decoder made exactly one symbol correction in information corresponding with data from any of the chips, the controller identifies the index “A” of the row containing the one correction. At step 683, the controller reconstructs the GEC data associated with the row with exactly one symbol correction. Then, at step 695, the controller decodes the data of the cache line and outputs the data of the cache line.

In addition, while carrying cut the row-by-row decoding, at step 685, the controller may determine a decoding failure at a particular row (e.g., row “A”). That means that the error detection code detected more than one error (e.g., error in LED and GEC) and that the column error occurred in column “A.” In that case, the controller may implement step 687 to reconstruct the GEC data as described above with respect to step 883. The controller may them move to step 695 to decode the data of the cache line and to output the data of the cache line. Alternatively, the controller may detect two symbol corrections in two different columns and rows (at step 690). In that case, the controller may declare a decoding failure (at step 692).

Therefore, under any single column error pattern the above decoder always detects the error and declares a failure only in some fraction of the cases when the GEC data contains an error and there are precisely two other byte errors in the column, with one of these errors having the same column and row indices. The fraction of column patterns with this property, for a given column, is no more than 6/2⁴⁸.

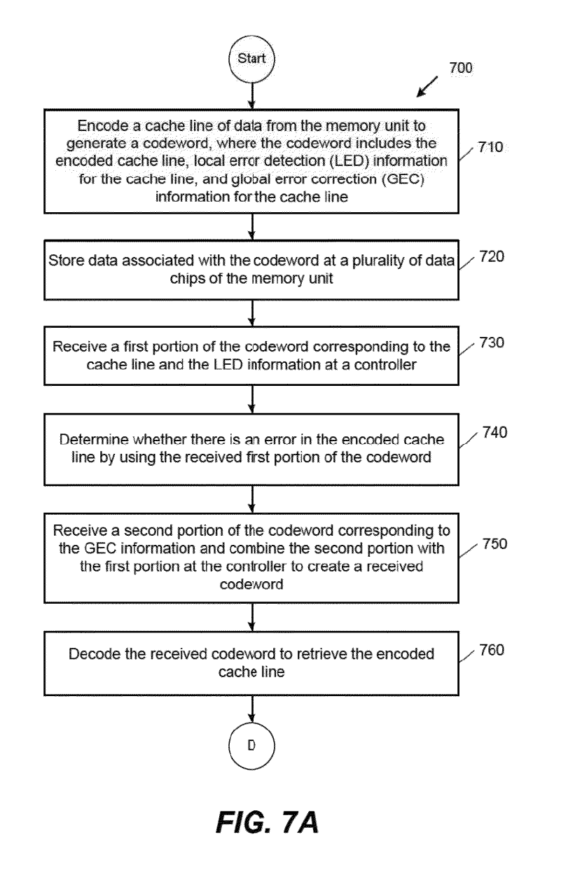

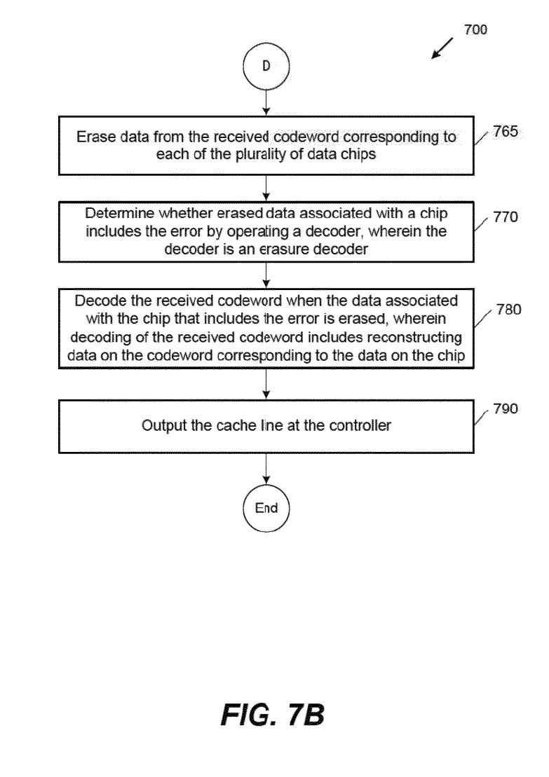

FIG. 7 illustrates a flow chart showing an example of an alternative method 700 for operating a memory unit during a memory access operation. In one example, the method 700 can be executed by the memory controller 102 of the processor 101. Various steps described herein with respect to the method 700 are capable of being executed simultaneously, in parallel, or in an order that differs from the illustrated serial manner of execution. The method 700 may be executed in the form of instructions encoded on a non-transitory machine-readable storage medium executable by a processor 101. In one example, the instructions for the method 700 are stored in the coding module.

The method 700 begins at step 710, where the controller encodes (e.g., by using an encoder) a cache line of data from the memory unit to generate a codeword. The encoded cache line includes 64 bytes of data and the memory unit includes nine x8 data chips and a burst length of eight. In one example, the code used by the encoder is a (81, 64, 18) systematic, maximum distance separable (MDS) code (e.g., Reed-Solommon code, etc.). Thus, the, proposed code includes a codeword of 81 symbols, each symbol being one byte, the code encodes 64 bytes of input data, and the codewords have a minimum distance of 18 symbols. The following paragraphs are described with respect to using a systematic code It is to be understood that a non-systematic code may also be used.

Next, the controller stores data associated with the codeword at a plurality of data chips of the memory unit at step 720). During encoding, the encoder encodes the 84 bytes of data with 17 bytes of redundancy. In one example, the 64 coded bytes of data are stored in the first eight chips in the memory, the eight bytes of LED redundancy data are stored on the ninth chip, and the nine bytes of redundancy become the GEC data and are each stored on one of the corresponding nine chips. The encoded data bytes and the LED data create a first tier of protection for the cache line and the GEC data creates a second tier of protection for the cache line. Therefore, the generated codeword includes the encoded cache line, local error detection (LED) information for the cache line, and global error correction (GEC) information for the cache line.

In one example, encoding may be carried out by a standard encoder (e.g., standard systematic Reed-Solomon encoder). Thus, the encoder generates a 81 byte long codeword, which when decoded (e.g., by using a burst-error list decoding technique), is capable of detecting all single chip error patterns and correcting all but a ½⁶⁴ fraction of single column/chip error patterns.

Based on a memory read request at step 730, the controller receives a first portion of the codeword from the memory unit, where the received first portion corresponds to the cache line and the LED information. Next, the controller determines whether there is an error in the encoded cache line by using the received first portion of e codeword (740). In one example, the controller computes eight parity checks based on the encoded data and compares the eight parity checks to the LED information associated with the cache line. If all computed parity checks and the bytes of LED data match, the controller determines that there is no error in the transmitted cache line and sends the systematic cache line data as output (i.e., without retrieving the GEC data from the memory). Alternatively, if at least one of the parity checks fails, the controller determines that there is error in the received cache line.

If the controller determines that the received cache line includes an error the controller receives a second portion of the codeword corresponding to the GEC information from the memory unit (at step 750). The controller combines the second portion with the first portion at the controller to create a received codeword. Next, at step 760, the controller decodes the receivel codeword to retrieve the encoded cache line (e.g., by operating a decoder to correct the error and to decode/correct the encoded information). In that situation, using a standard decoding to decode/correct is not sufficient, because the error may indicate there may be up to nine bytes of error in a chip and the controller needs 18 bytes of redundancy to correct these errors. In the described implementation, only 17 bytes of redundancy are generated.

In one example, when the controller determines that an error exists in the coded cache line, the controller arranges the received codeword into a 9×9 array of bytes, where the nine columns correspond to the nine chips in the memory. Therefore, the decoding operation is run on the entire 81 bytes of the received codeword (data, LED, and GEC). In one example, the first eight rows of the array include the encoded cache line data and the LED data and the ninth row includes the GEC data. At step 765, the controller erases, in order, data from the received codeword corresponding to each of the plurality of data chips. In other words, the controller erases in a sequence each of the columns of the 9×9 array.

After a column is erased, the controller determines whether erased data associated with a chip includes the error by operating a decoder (at step 770). In some examples, the decoder is a standard Reed Solomon code erasure decoder. In other words, the controller (i.e., using the decoder) determines whether the erased column corresponding to a specific chip in the memory includes the error (i.e., identifies the bad chip). For example, after each column is erased, the controller applies a standard Reed Solomon code erasure decoder or the controller attempts to solve a system of equations over a Galois field (2⁸) obtained by treating the erased locations as unknowns and by using the equations arising from the 17 parity checks. Thus, there are nine unknowns and 17 equations. In one example, standard linear algebraic methods over finite fields can be used either to obtain a solution to the equations or to establish that no solution exists. When the controller identifies that the Reed Solomon code erasure decoder has failed or that no solution to the equations exist, that means that the erased column was error free and the decoder canrot properly decode the information from the array because another column includes errors. Then, the controller moves to erasing the next column in the array.

On the other hand, when the controller identifies that the standard Reed Solomon erasure decoder succeeds or a solution to the equations exists, the corresponding decoded erased column or the corresponding solution is considered to be a tentative correction to the erased column and is added to a list. The controller then proceeds to erase the remaining columns in the array. If no other successful erasure decoding occurs or no other solution to the equations is found, the controller determines that the previously identified column corresponds to the failed chip and decodes the codeword. It however, the controller finds another erased column that leads to successful erasure decoding or to a solution of the equations, a decoding failure is declared. Thus, at step 780, the controller decodes the received codeword when the data associated with the chip that includes the error is erased (i.e., the data in the column associated with the failed chip is erased). Decoding of the received codeword also includes reconstructing the data on the received codeword corresponding to the data on the failed chip. For example, during the decoding operation, the controller first reconstructs the data on the column that corresponds to the failed chip and then decodes the entire codeword. In the case of a systematic code, additional decoding is unnecessary as the cache line data is part of the reconstructed codeword. At step 790, the controller outputs the decoded cache line at the controller.

As rioted above, in some examples, the encoder and decoder described with respect to method 700 may be non-systematic. In that situation, encoding may be done by using any encoder for above-identified cede parameters. The controller may store the generated first 72 bytes (coded cache line +LED) in the data chips to create the first tier of protection and the nine bytes of GEC data among all the chips as described above with respect to method 700. During a memory read operation, the controller may receive the first tier of protection (72 bytes of data+LED) and nine erasures (i.e., the unread nine GEC bytes are marked as erasures). The controller may use a standard decoder (e.g., Reed-Solomon) to correct the nine erasures. If the decoding succeeds, then an error free condition may be declared and the decoded data is sent as the decoded cache line. If decoding fails, an error is detected and the controller may retrieve the GEC data from the memory. Then, decoding may proceed as described with respect to method 700. If this second round of decoding is successful, the decoded data corresponding to the erased-column trial that succeeded is sent as the decoded cache line.

1. A system for operating the system comprising:
a processor having a memory controller in communication with the memory unit, the memory controller to:
perform an encoding operation to
divide data in a cache line into a plurality of groups,
encode, with an encoder of the controller, the data in the plurality of groups to generate a plurality of codewords, where each codeword is distributed among a plurality of chips in the memory unit, and the codewords include the data of the cache line, local error detection (LED) data for the cache line, and global error correction (GEC) data for the cache line,
generate a first tier of protection for the cache be from a first portion of the plurality of codewords, where the first tier of protection is stored across the plurality of chips and includes LED data for the cache line combined with the data of the cache line,
generate a second tier of protection for the cache line from a second portion of the plurality of codewords, where the second tier of protection is distributed among the plurality of chips and includes the GEC data for the cache line; and
perform a decoding operation to:
determine whether an error exists in the data of the cache line based on received information corresponding to the first tier of protection,
decode the data of the cache line using a decoder, and
output the data of the cache line at the controller.

2. The system of claim 1, wherein the memory controller is to:
retrieve information corresponding to the first layer tier of protection generated from the plurality of codewords;
compute a plurality of parity checks for the information corresponding to the first tier of protection;
compare the plurality of parity checks with the LED data from the plurality of codewords to determine whether an error exists in the data of the cache line;
retrieve GEC data from the plurality of chips of the memory unit when an error exists in the data of the cache line;
determine whether there is an error in the GEC data; and
decode the data of the cache line when the GEC data does not include an error to correct the error in the data of the cache line and to output corrected data of the cache line.

3. The system of claim 2, wherein the memory controller is to:
operate the decoder when the GEC data includes an error, where the decoder is a row-by-row decoder;
determine whether the decoder made at least two symbol corrections in information corresponding with the data from one of the chips;
reconstruct the GEC data associated with the chip with at least two symbol corrections;
determine whether the decoder made exactly one symbol correction in information corresponding with data from any of the chips;
reconstruct the GEC data associated with a row with exactly one symbol correction; and
decode the data of the cache line and output data of the cache line.

4. The system of claim 1, whereof the cache line includes 64 bytes, each of the plurality of groups with data from the cache line includes eight bytes, and the memory unit includes nine x8 data chips and a burst length of eight.

5. The system of claim 1, wherein a code used by the encoder includes codewords of ten symbols, each symbol being one byte, the code encodes eight bytes of data, and the codewords have a minimum distance of three symbols.

6. A method for operating a memory unit, the method comprising:
encoding, with an encoder of a controller data from a cache line divided in a plurality of groups;
generating, with the controller, a plural of codewords that include the data of the cache line, first local error detection (LED) data for the cache line, and global error correction (GEC) data for the cache line;
storing, with the controller, the LED data for the cache line combined with the data of the cache line across a plurality of chips in the memory unit to create a first tier of protection for the cache line, where the LED data and the data of the cache line are retrieved from a first portion of the codewords;
storing, with the controller, the GEC data for the cache line across the plurality of chips to create a second tier of protection for the cache line, where the LED data is retrieved from a second portion of the codewords;
receiving, at the controller, information corresponding to the first ter of protection;
determining, with the controller, whether an error exists in the data of the cache line;
decoding, with a decoder, the data of the cache line, and outputting, with the controller, the data of the cache line at le controller.

7. The method of claim 6, wherein decoding the data of the cache further comprises:
computing a plurality of parity checks for the information corresponding to the first tier of protection;
comparing the plurality of parity checks with the LED data from the plurality of codewords to determine whether an error exists in the data of the cache line;
retrieving GEC data from the plurality of chips of the memory unit when an error exists in the data of the cache line;
determining whether there is an error in the GEC data;
decoding the data of the cache line when the GEC data does not include an error; and
outputting corrected data of the cache line.

8. The method of claim 6, further comprising:
operating the decoder when the GEC data includes en error, where the decoder is row-by-row decoder;
identifying at least two symbol corrections in information corresponding with the data from one of the chips;
correcting the GEC data associated chip with least two symbol corrections;
identifying exactly one symbol corrections in information corresponding with the data from any of the chips;
correcting the GEC data associate with a row with exactly one symbol correction; and
decoding the data of the cache line and outputting data of the cache line.

9. The method of claim 6, wherein the encoder uses a code that includes codewords of ten symbols, each symbol being one byte, the code encodes eight bytes of data, and the codewords have a minimum distance of three symbols.

10. The method of claim 6, wherein the groups with data from the cache are eight, each of the plurality of groups with data from the cache line includes eight bytes, the memory unit includes nine x8 data chips and a burst length of eight.

11. A method for operating a memory unit, the method comprising:
encoding, with an encoder, a cache line of data from the memory unit to generate a codeword, where the codeword includes the encoded cache line, local error detection (LED) information for the cache line, and global error correction (GEC) information for the cache line;
storing data associated with the codeword at a plurality of data chips of the memory unit;
receiving a first portion of the codeword corresponding to the cache line and the LED information at a controller;
determining, with the controller, whether there is an error in the encoded cache line by using the received first portion of the codeword;
receiving a second portion of the codeword corresponding to the GEC information and combining the second portion with the first portion at the controller to create a received codeword; and
decoding the received codeword to retrieve the encoded cache line, where decoding the received codeword includes:
erasing, in order, data from the received codeword corresponding to each of the plurality of data chips,
determining whether erased data associated with a chip includes the error by operating a decoder, wherein the decoder is n erasure decoder,
decoding the received codeword when the data associated with the chip that includes the error is erased, wherein decoding of the received codeword includes reconstructing data on the received codeword corresponding to the data on the chip, and
outputting the cache line at the controller.

12. The method of claim 11, whereof the cache line includes 64 bytes of data, and wherein the memory unit includes nine x8 data chips and a burst length of eight.

13. The method of claim 11, wherein a code used by the encoder is a maximum distance separable code, and wherein the code includes codewords of 81 symbols, each symbol being one byte, the code encodes 64 bytes of data, and the codewords have a minimum distance of 18 symbols.

14. The method of claims 13, wherein the codeword include 64 bytes of encoded data, bytes of LED, and nine bytes of GEC.

15. The method of claim 14, wherein determining whether there is an error in the encoded cache line includes computing eight panty checks based on the encoded data and comparing the eight parity checks to the LED information.
